(19) United States
(12) Patent Application Publication
(10) Pub. No.: US 2016/0347231 A1
(43) Pub. Date: Dec. 1, 2016

(54) DUNNAGE BAG ARRANGEMENT

(71) Applicant: SIGNODE INDUSTRIAL GROUP S.A. PROPRIETARY LIMITED, Johannesburg (ZA)

(72) Inventor: Bester Jacobus Pansegrouw, Ottery (ZA)

(21) Appl. No.: 15/114,023

(22) PCT Filed: Jan. 27, 2015
(86) PCT No.: PCT/IB2015/050594

§ 371 Date: Jul. 25, 2016

(30) Foreign Application Priority Data
Jan. 27, 2014 (ZA) 2014/00631

(51) Int. Cl. B60P 7/06; B65D 81/05

(52) U.S. Cl. CPC B60P 7/065; B65D 81/052

(57) ABSTRACT

Various embodiments of the present disclosure provide a dunnage bag arrangement for securing loads. The dunnage bag arrangement includes an inflatable dunnage bag having a gastight inflatable bladder, a first face side, a second face side, a top edge, a bottom edge, a first side edge and a second side edge; and at least one inflation valve adapted for inflating the gastight inflatable bladder and being located on the first face side and/or the second face side.

### PRIORITY CLAIM

This application is a national stage entry of PCT/IB2015/050594, filed on Jan. 27, 2015, which claims priority to and the benefit of South African Patent Application No. 2014/00631, which was filed on Jan. 27, 2014, the entire contents of each of which are incorporated herein by reference.

### FIELD

The present disclosure relates to a dunnage bag arrangement.

More particularly, the present disclosure relates to an inflatable dunnage bag arrangement.

### BACKGROUND

Conventional inflatable and disposable dunnage bags include a gastight bladder, usually constructed from polyethylene material, surrounded by an outer protective and supportive casing consisting of at least one ply of paper material. These dunnage bags are used to fill spaces between cargo or between the cargo and the walls of freight carriers to prevent the cargo from shifting and damaging either the cargo itself and/or the walls of the freight carrier. The dunnage bags are typically placed between the cargo in a deflated condition and are subsequently inflated with a gas. The pressure of the gas in the dunnage bags is determined by the application, the size of the dunnage bags, and the wall composition of the dunnage bags.

The problem with known dunnage bags is that some of the voids are so small that when in the deflated position the inflation valve is in an inaccessible position, for example too low. The disadvantages are that it is frustrating for the operator, is time consuming, sometimes the bag has to be deflated to reposition correctly, and sometimes it takes two operators to position and inflate a dunnage bag.

It is an object of the invention to suggest a dunnage bag arrangement that will assist in overcoming these problems.

### SUMMARY

According to the one embodiment of the present disclosure, a dunnage bag arrangement for securing loads includes:
(a) an inflatable dunnage bag having a gastight inflatable bladder, a first face side, a second face side, a top edge, a bottom edge, a first side edge and a second side edge; and
(b) at least one inflation valve adapted for inflating the gastight inflatable bladder and being located on the first face side and/or the second face side.

The inflation valve may be located near the first side edge and/or the second side edge.

The inflation valve may be located some distance from the top edge and/or the bottom edge.

The inflation valve may be located at least 5 to 30 mm from the first side edge and/or the second side edge.

The inflation valve may be located midway between the top edge and/or the bottom edge.

According to another embodiment of the present disclosure, a method for securing loads includes the steps:
(a) of providing in a void between loads to be secured, an inflatable dunnage bag having a gastight inflatable bladder, and having a first face side, a second face side, a top edge, a bottom edge, a first side edge and a second side edge;
(b) of providing at least one inflation valve adapted for inflating the gastight inflatable bladder and being located on the first face side and/or the second face side; and
(c) of inflating the inflatable dunnage bag, by means of the inflation valve, to secure the loads.

The dunnage bag may include at least one reinforcing sleeve adapted to surround the gastight inflatable bladder and being made of at least one material ply, the sleeve having a first opening and a second opening, and the sleeve being folded and sealed and/or stitched to close off at least one of the openings.

The sleeve may be made of at least one material ply selected from the material group consisting of paper, plastics material, woven PP (polypropylene), HDPE (high-density polyethylene) and PVC (polyvinylchloride).

In the case of paper sleeves, the sleeve ends may consist of flaps formed by cutting the sleeve at the opening being closed.

The flaps at one end may be folded towards each other to close off the respective opening and/or at one end may be glued to each other to permanently close off the respective opening.

In the case of woven polypropylene sleeves, the sleeve ends are stitched.

The dunnage bag may be provided with one to eight sleeves.

The inflatable bladder may be made of polyethylene.

The inflatable bladder may be provided with an inflation valve. The inflation valve may protrude to the exterior at one of the openings. The dunnage bag may be used in voids between 0.5 inch and 75 inches. The dunnage bag may be substantially rectangular in shape. The dunnage bag may be disposable.

The dunnage bag may be applicable in conjunction with void fillers and/or be applicable in conjunction with friction panels.

At least 50% of the exterior surface area of the dunnage bag may be adapted in use to be in contact with a load to be secured.

The contact may be direct and/or indirect.

### BRIEF DESCRIPTION OF DRAWINGS

The invention will now be described by way of example with reference to the accompanying schematic drawings.

FIG. 1 is a front side view of one example dunnage bag arrangement of the present disclosure before being inflated.

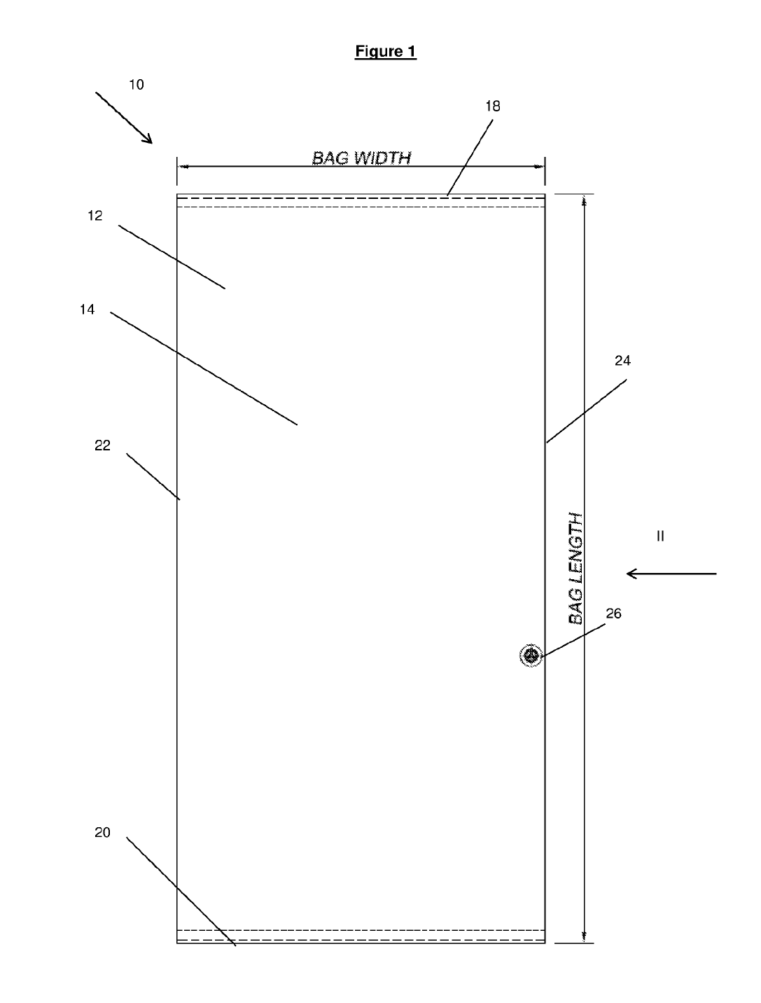

FIG. 2 is a side view of the dunnage bag arrangement as seen from arrow II in FIG. 1.

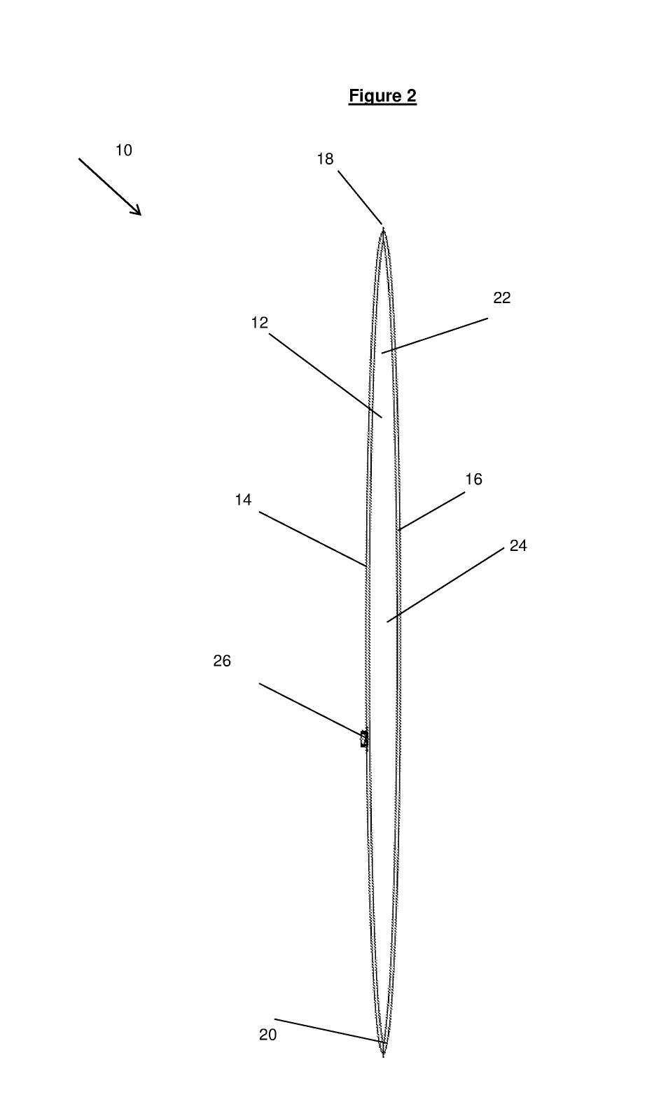

### DETAILED DESCRIPTION

Referring to the drawings, there is shown a dunnage bag arrangement, generally indicated by reference numeral 10, in accordance with one example embodiment of the present disclosure. The dunnage bag arrangement 10 for securing loads includes:
(a) an inflatable dunnage bag 12 having a gastight inflatable bladder, a first face side 14, a second face side 16, a top edge 18, a bottom edge 20, a first side edge 22 and a second side edge 24; and
(b) an inflation valve 26 adapted for inflating the gastight inflatable bladder and being located on the first face side 14.

The inflation valve 26 is preferably located near the second side edge 24.

The inflation valve 26 is preferably be located some distance from the top edge 18 and the bottom edge 20.

The inflation valve 26 is preferably located at least 5 to 30 mm from the second side edge 24.

The inflation valve 26 is preferable located midway between the top edge 18 and the bottom edge 20.

The dunnage bag 12 includes at least one reinforcing sleeve adapted to surround the gastight inflatable bladder and being made of at least one material ply, the sleeve having a first opening and a second opening, and the sleeve being folded and sealed and/or stitched to close off at least one of the openings.

The sleeve is made of at least one material ply selected from the material group consisting of paper, plastics material, woven PP (polypropylene), HDPE (high-density polyethylene) and PVC (polyvinylchloride). In the case of paper sleeves, the sleeve ends consist of flaps formed by cutting the sleeve at the opening being closed. The flaps at one end are folded towards each other to close off the respective opening. The flaps at one end are glued to each other to permanently close off the respective opening. In the case of woven polypropylene sleeves, the sleeve ends are stitched.

The dunnage bag arrangement can be provided with one to eight sleeves. The dunnage bag may include an inner polyethylene layer or sleeve and an outer woven polypropylene layer or sleeve. The inflatable bladder is made of polyethylene. The inflatable bladder is provided with an inflation valve. The inflation valve protrudes to the exterior at one of the openings. The dunnage bag arrangement can be used in voids between 0.5 inch and 75 inches. The dunnage bag arrangement can be substantially rectangular in shape. The dunnage bag arrangement can be disposable. The dunnage bag arrangement is applicable in conjunction with void fillers. The dunnage bag arrangement is applicable in conjunction with friction panels. At least 50% of the exterior surface area of the dunnage bag can be adapted to be in contact with a load to be secured. The contact can be direct or indirect.

Hence the dunnage bag arrangement 10 according to the invention, provides a method of securing load, includes the steps
(a) of providing in a void between loads to be secured, an inflatable dunnage bag 10 having a gastight inflatable bladder, and having a first face side 14, a second face side 16, a top edge 18, a bottom edge 20, a first side edge 22 and a second side edge 24;
(b) of providing at least one inflation valve 26 adapted for inflating the gastight inflatable bladder and being located on the first face side 14 and/or the second face side 16; and (c) of inflating the inflatable dunnage bag 12, by means of the inflation valve 26, to secure the loads.

This positioning of the inflation valve 26 facilitates the operator to inflate the dunnage bag in small and narrow and low inaccessible voids.

1-21. (canceled)

22. An inflatable dunnage bag including:
a gastight inflatable bladder;
a first face side;
a second face side;
a top edge;
a bottom edge;
a first side edge;
a second side edge; and
an inflation valve located on one of the first and second face sides and usable to inflate the gastight inflatable bladder.

23. The dunnage bag of claim 22, wherein the inflation valve is located near one of the first and second side edges.

24. The dunnage bag of claim 22, wherein the inflation valve is spaced apart from at least one of the top and bottom edges.

25. The dunnage bag of claim 22, wherein the inflation valve is located at least 5 mm to 30 mm from one of the first and second side edges.

26. The dunnage bag of claim 22, wherein the inflation valve is located about midway between the top edge and the bottom edge.

27. The dunnage bag of claim 22, which includes a reinforcing sleeve surrounding the gastight inflatable bladder, the reinforcing sleeve having a first opening and a second opening, the first and second openings each being sealed or stitched closed.

28. The dunnage bag of claim 27, wherein the reinforcing sleeve is made of at least one selected from the group consisting of paper, plastic, woven polypropylene, high-density polyethylene, and polyvinylchloride.

29. The dunnage bag of claim 28, wherein when the reinforcing sleeve is made of paper, the first and second openings are each sealed closed, and when the reinforcing sleeve is made of woven polypropylene, the first and second openings are each stitched closed.

30. The dunnage bag of claim 29, wherein when the reinforcing sleeve is made of paper, the first and second openings are sealed closed using glue.

31. The dunnage bag of claim 27, which includes one to eight reinforcing sleeves.

32. The dunnage bag of claim 22, wherein the inflatable bladder is made of polyethylene, and which includes an outer woven polyethylene sleeve.

33. The dunnage bag of claim 22, wherein the inflatable bladder is made of polyethylene.

34. The dunnage bag of claim 22, which is substantially rectangular.

35. A method for securing loads, the method including:
(a) positioning an inflatable dunnage bag in a void between the loads to be secured, the dunnage bag including a gastight inflatable bladder, a first face side, a second face side, a top edge, a bottom edge, a first side edge, a second side edge, and an inflation valve located on one of the first and second face sides; and
(b) inflating the dunnage bag via the inflation valve to secure the loads.

36. The method of claim 35, wherein the void is between 0.5 inch and 75 inches.

37. The method of claim 35, which includes disposing of the dunnage bag after use.

38. The method of claim 35, which includes positioning and inflating the dunnage bag such that, in use, at least 50% of an exterior surface area of the dunnage bag contacts the loads.

39. The method of claim 38, wherein the contact is at least one of indirect and direct.

40. The method of claim 35, which includes using the dunnage bag in conjunction with at least one of a void filler and a friction panel.
